(19) United States
(12) Patent Application Publication
(10) Pub. No.: US 2002/0144523 A1
(43) Pub. Date: Oct. 10, 2002

(54) Optical fiber drawing furnace

(75) Inventors: Nobuaki Orita, Tokyo (JP); Yoshiyuki Sakata, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 09/971,563

(22) Filed: Oct. 9, 2001

(30) Foreign Application Priority Data
Apr. 4, 2001 (JP) 2001-106303

(51) Int. Cl. C03B 37/029

(52) U.S. Cl. 65/537; 65/533

(57) ABSTRACT

An optical fiber drawing furnace, comprising a furnace core tube where an optical fiber preform is inserted, fused with heat by a cylindrical heating element that is provided around the furnace core tube, and drawn to an optical fiber, wherein a protective tube is provided being contacted with an upper end edge of the furnace core tube.

### FIELD

The present invention relates to an optical fiber drawing furnace for obtaining an optical fiber by fusing an optical fiber preform with heat.

### BACKGROUND

Conventionally, drawing of an optical fiber has been generally carried out in such a manner that (a) an optical fiber preform is inserted from an upper end of an optical fiber heating furnace, having a cylindrical heating element and a furnace core tube, (b) the inserted optical fiber preform is fused with heat, at a center portion having the maximum temperature in the cylindrical heating element, and the fused optical fiber preform is drawn to be made into an optical fiber having a desirable external diameter, and (c) the resultant optical fiber is drawn out from a lower end of the heating furnace.

The furnace core tube to be used for drawing the optical fiber preform is usually made of carbon, and an inert gas, such as Ar, He, or the like, is flowed into the furnace. In this case, Si and SiO₂, which generate when the optical fiber preform is fused in the optical fiber drawing furnace, react with a furnace core tube made of carbon, so that they are converted to SiC or SiO₂. Then, the resultant SiC or SiO₂ adhere onto and deposit at a low-temperature portion of the upper part of the furnace core tube. Particularly, in the case of drawing a large-type optical fiber preform, since air is flowed into the furnace core tube through an upper opening portion of the furnace core tube, it occurred frequently that a carbon furnace core tube is wasted by oxidation generating fine-particles. In addition the deposits adhered to the upper portion of the furnace core tube are peeled off. As a result, such a problem may be caused that, when these fine particles or the deposits peeled off contact with the optical fiber, breaking of the optical fiber or deterioration of mechanical strength of the optical fiber may occur.

On the other hand, in addition to the furnace core tube made of carbon, a furnace core tube made of zirconia has been also used. Zirconia is capable of being used in an oxygen atmosphere, so that the problem of the furnace core tube becoming wasted with oxidation does not occur. However, as well as the furnace core tube made of carbon, the deposits adhere onto the low-temperature portion of the upper part of the furnace core tube. Thus there is occurred the problem of the breaking of the optical fiber and the deterioration of the mechanical strength of the optical fiber, once the deposits are peeling off.

### SUMMARY

The present invention is an optical fiber drawing furnace, comprising a furnace core tube where an optical fiber preform is inserted, fused with heat by a cylindrical heating element that is provided around the furnace core tube, and drawn to an optical fiber, wherein a protective tube is provided being contacted with an upper end edge of the furnace core tube.

Other and further features and advantages of the invention will appear more fully from the following description, take in connection with the accompanying drawings.

### BRIEF DESCRIPTION OF THE DRAWINGS

FIG. 1 is a schematic view according to a first embodiment of the present invention.

FIG. 2 is a cross sectional view of a protective tube employed in the first embodiment of the present invention.

FIG. 3 is a cross sectional view of a protective tube employed in a second embodiment of the present invention.

FIG. 4 is a cross sectional view of a protective tube employed in a third embodiment of the present invention.

FIG. 5 is a schematic view according to an example of a conventional optical fiber drawing furnace.

### DETAILED DESCRIPTION

According to the present invention, there is provided the following means:

(1) An optical fiber drawing furnace, comprising a furnace core tube where an optical fiber preform is inserted, fused with heat by a cylindrical heating element that is provided around the furnace core tube, and drawn to an optical fiber, wherein a protective tube is provided being contacted with an upper end edge of the furnace core tube.

(2) The optical fiber drawing furnace according to the above item (1), wherein the protective tube is made of quartz.

(3) The optical fiber drawing furnace according to the above item (1) or (2), wherein a distance between an upper end position of the furnace core tube, at which the protective tube and the furnace core tube contact with each other, and a center portion of the heating element, is longer than a length that is 1.5 times an inner diameter of the furnace core tube.

(4) The optical fiber drawing furnace according to any one of the above items (1) to (3), wherein the inner diameter of the lower end portion of the protective tube is equal to the inner diameter of the furnace core tube, and the inner diameter of the upper end portion of the protective tube is equal to or larger than the inner diameter of the furnace core tube.

A preferable embodiment of an optical fiber drawing furnace according to the present invention will be explained in detail with reference to the drawings.

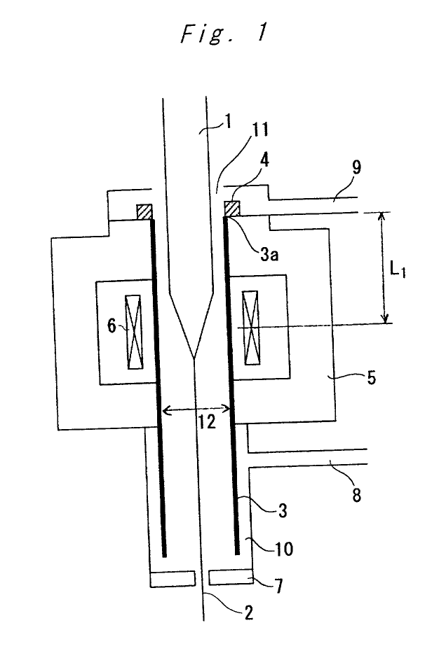

As shown in FIG. 1, a furnace core tube 3, in which an optical fiber preform 1 is inserted, is provided at a central portion of a furnace body of an optical fiber drawing furnace. In the furnace body, a heat insulating material 5 and a heating element 6 encircling the furnace core tube 3 are disposed. Inert gas induction holes 8 and 9 are arranged at an upper side portion of an inert gas atmosphere portion 10 and an upper portion of the furnace core tube 3. A shatter 7 is disposed on a lower portion of the furnace core tube 3 to repress invasion of the outside air. The inert gas of a predetermined amount is flowed through the inert gas atmosphere portion 10 from the inert gas induction hole 8, then is flowed from the lower inside part of the furnace core tube 3 to the upper part thereof. Additionally, in order to prevent invasion of the air from an upper opening portion 11, the gas (seal gas) is also flowed in the furnace core tube 3 from the inert gas induction hole 9.

A protective tube 4 is arranged on a furnace core tube upper end edge 3a. This protective tube protects the furnace core tube from the air, namely, the protective tube plays a role to prevent the furnace core tube from being exposed to the air, and being wasted by oxidation. In other words, due to arrangement of the protective tube 4, the carbon furnace core tube is not wasted by oxidation because of flowing of the air from the opening portion 11 of the upper portion of the protective tube 4. Accordingly, it does not occur that the carbon particles are generated, or the deposits adhering to the upper portion of the furnace core tube are peeled off. The deposits further adhere to the protective tube 4. However, these deposits are not peeled off in the furnace unless a large amount of deposits adhere thereto, since the protective tube is not wasted by oxidation.

The protective tube 4 is made of a material, which has an excellent heat resistance and is not wasted by oxidation. Zirconia may be available as this material, however, quartz is particularly preferable. An inner diameter of the lower end portion of the protective tube 4 is as same as an inner diameter of the furnace core tube 12, in view of preventing oxidation and waste of the furnace core tube 3. In this case, when the inner diameter of the lower end of the protective tube 4 is smaller than the inner diameter of the furnace core tube 12, it is also possible to prevent the furnace core tube 3 from being wasted by oxidation. However, this case is not preferable since it is feared that the deposits adhering to the protective tube 4 fall down in the furnace core tube 3. Accordingly, as described above, the inner diameter of the lower end portion of the protective tube 4 should be equal to the inner diameter of the furnace core tube 12. On the other hand, it is preferable that the inner diameter of the upper portion of the protective tube 4 is equal to the inner diameter of the furnace core tube 12, or is larger than the inner diameter of the furnace core tube 12, in view of preventing the falling of the adhesive deposits. It is particularly preferable that the inner diameter of the upper portion of the protective tube 4 is larger than the inner diameter of the furnace core tube 12.

Further, it is preferable that a distance between the upper end position of the furnace core tube 3, where the protective tube 4 contacts the furnace core tube 3, and a center portion of the heating element 6, is longer than 1.5 times of the inner diameter of the furnace core tube 12. This is because it is possible to prevent a damage from occurring due to the protective tube becoming breakable by crystallization.

A front end portion of the optical fiber preform 1, which was inserted from the upper portion of the furnace core tube 3, is fused with heat at a portion having the maximum temperature of the furnace core tube 3, so that the optical fiber preform is drawn to be made into the optical fiber 2. After the drawn optical fiber 2 is coated with a resin by a coating apparatus (not illustrated), the coated fiber is wound by a winding machine.

According to the present invention, disposing the protective tube so as to contact with the upper end of the furnace core tube of the optical fiber drawing furnace enables to prevent oxidization and deterioration of the furnace core tube and falling of adhesive deposits such as SiO₂, SiC, or the like. Therefore, it is possible to prevent breaking of an optical fiber during drawing the optical fiber, and deterioration of the mechanical strength of the optical fiber.

The present invention will be explained in more detail based on the following examples, however, the present invention is not limited thereto.

### EXAMPLE

### Example 1

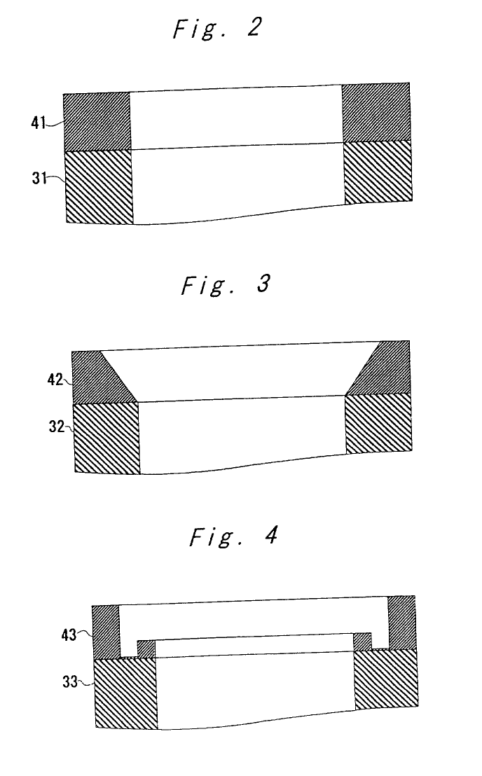

Using the optical fiber drawing furnace shown in FIG. 1, an optical fiber preform 1 having the outer diameter 120 mm was inserted from the upper portion of a furnace core tube 3 made of carbon, whose inner diameter of the furnace core tube 12 was 150 mm, through a protective tube 4. When the protective tube is represented as 41, and the furnace core tube is represented as 31, as shown in FIG. 2, the protective tube 41 was disposed on the upper end edge of the furnace core tube 31 whose shape was 180 mm of an outer diameter, 150 mm of an inner diameter, and 30 mm of a length. Further, a length L₁ between a center portion of a heating element 6 and the upper end of the furnace core tube 3 was set to be 240 mm. The furnace core tube 3 was heated by the heating element 6, and the maximum temperature at the center portion of the heating element 6 was set to approximately 2,200° C. During heating the furnace core tube 3, Ar of 20 SLM was flowed from the inert gas induction holes 8 and 9 into the furnace core tube 3 from the beneath to the upper part therein and the Ar of 20 SLM was also flowed from the upper part of the furnace core tube 3. In this case, 1 SLM represents 1 l/min under a standard state that a temperature 20° C. and an atmospheric pressure 1 atom. In the above-described conditions, when the optical fiber of 10,000 km was continuously drawn, the adhesive deposits, such as SiO₂, SiC, or the like, was formed on the upper portion of the furnace core tube 3, and the adhesive deposits, such as SiO₂ or the like, was formed on the surface of the protective tube 4. However, degradation of the furnace core tube 3 with oxidation was repressed, there was a little of falls of the adhesive deposits in the furnace core tube, and the number of the breaking of the optical fiber during drawing was only twice.

### Example 2

When the protective tube is represented as 42, and the furnace core tube is represented as 32, as shown in FIG. 3, an optical fiber of 10,000 km was continuously drawn in the same manner as in the above Example 1, except that the protective tube 42, whose shape was a taper-type having 170 mm of an inner diameter of an upper portion, 150 mm of an inner diameter of a lower portion, and 30 mm of a length, was arranged at the upper end edge of the furnace core tube 32. In this case, the adhesive deposits on the protective tube almost never fell down, and the number of the breaking of the optical fiber during drawing was only one time.

### Example 3

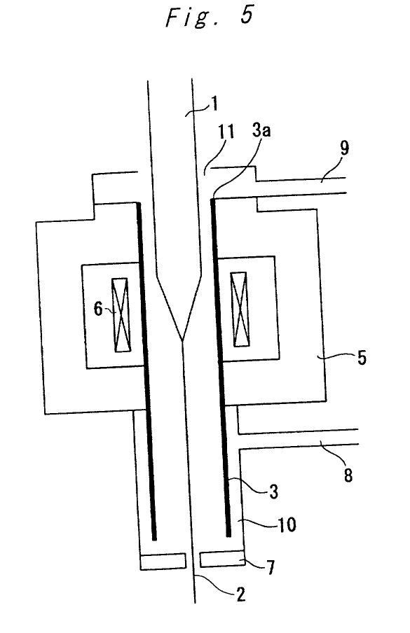

When the protective tube is represented as 43, and the furnace core tube is represented as 33, as shown in FIG. 4, an optical fiber of 10,000 km was continuously drawn in the same manner as in the above Example 1, except that the protective tube 43, whose sharp was a double tube in structure composed of an inner cylinder having 150 mm of an inner diameter and 10 mm of a length, and an outer cylinder having 170 mm of an inner diameter and 30 mm of a length, was arranged at the upper end edge of the furnace core tube 33. In this case, the adhesive deposits on the protective tube also almost never fell down, and the number of the breaking of the optical fiber during drawing was only one time.

### Comparative Example 1

As shown in FIG. 5, an optical fiber of 10,000 km was continuously drawn in the same manner as in the above Example 1, except that the protective tube was not used. In this case, the furnace core tube 3, was heavily degraded by oxidation, many adhesive deposits fell down from the upper portion of the furnace core tube 3, and the number of the breaking of the optical fiber during drawing was as much as six times.

Having described our invention as related to the present embodiments, it is our intention that the invention not be limited by any of the details of the description, unless otherwise specified, but rather be construed broadly within its spirit and scope as set out in the accompanying claims.

What is claimed is:

1. An optical fiber drawing furnace, comprising a furnace core tube where an optical fiber preform is inserted, fused with heat by a cylindrical heating element that is provided around the furnace core tube, and drawn to an optical fiber, wherein a protective tube is provided being contacted with an upper end edge of the furnace core tube.

2. The optical fiber drawing furnace as claimed in claim 1, wherein the protective tube is made of quartz.

3. The optical fiber drawing furnace as claimed in claim 1, wherein a distance between an upper end position of the furnace core tube, at which the protective tube and the furnace core tube contact with each other, and a center portion of the heating element, is longer than a length that is 1.5 times an inner diameter of the furnace core tube.

4. The optical fiber drawing furnace as claimed in claim 2, wherein a distance between an upper end position of the furnace core tube, at which the protective tube and the furnace core tube contact with each other, and a center portion of the heating element, is longer than a length that is 1.5 times an inner diameter of the furnace core tube.

5. The optical fiber drawing furnace as claimed in claim 1, wherein the inner diameter of the lower end portion of the protective tube is equal to the inner diameter of the furnace core tube, and the inner diameter of the upper end portion of the protective tube is equal to or larger than the inner diameter of the furnace core tube.

6. The optical fiber drawing furnace as claimed in claim 2, wherein the inner diameter of the lower end portion of the protective tube is equal to the inner diameter of the furnace core tube, and the inner diameter of the upper end portion of the protective tube is equal to or larger than the inner diameter of the furnace core tube.

7. The optical fiber drawing furnace as claimed in claim 3, wherein the inner diameter of the lower end portion of the protective tube is equal to the inner diameter of the furnace core tube, and the inner diameter of the upper end portion of the protective tube is equal to or larger than the inner diameter of the furnace core tube.

8. The optical fiber drawing furnace as claimed in claim 4, wherein the inner diameter of the lower end portion of the protective tube is equal to the inner diameter of the furnace core tube, and the inner diameter of the upper end portion of the protective tube is equal to or larger than the inner diameter of the furnace core tube.
